(19) United States
(12) Patent Application Publication
(10) Pub. No.: US 2003/0159443 A1
(43) Pub. Date: Aug. 28, 2003

(54) Two-stage supercharging on a V-engine

(76) Inventor: Juergen Huter, Weissach (DE)

Correspondence Address: KENYON & KENYON, ONE BROADWAY, NEW YORK, NY, 10004, US

(21) Appl. No.: 10/367,381

(22) Filed: Feb. 14, 2003

(30) Foreign Application Priority Data
Feb. 28, 2002 (DE) 102 09 002.5

(51) Int. Cl. F02B 33/44

(52) U.S. Cl. 60/612

(57) ABSTRACT

A reciprocating piston internal combustion engine 1 includes at least one first and one second cylinder bank, to which at least two turbochargers are assigned, each having a charge-air compressor and an exhaust-gas turbine, one first turbocharger and one second turbocharger each being assigned both to the first cylinder bank and to the second cylinder bank and the first turbocharger being larger than the second turbocharger.

### CROSS-REFERENCE TO RELATED APPLICATIONS

The present application claims priority to Application No. 102 09 002.5, filed in the Federal Republic of Germany on Feb. 28, 2002, which is expressly incorporated herein in its entirety by reference thereto.

### FIELD OF THE INVENTION

The present invention relates to a reciprocating piston internal combustion engine having at least one first and one second cylinder bank, to which at least two turbochargers are assigned, each having a charge-air compressor and an exhaust-gas turbine.

### BACKGROUND INFORMATION

A multicylinder reciprocating piston internal combustion engine having cylinder banks arranged in a V-shape and two exhaust-gas turbochargers is described in German Published Patent Application No. 100 15 291. In this case the two exhaust-gas turbochargers of different size are operated either in series or in parallel according to demand, in order to improve the responsiveness and to obtain a large power output with high efficiency. At low engine speeds connection in series may be advantageous, the larger exhaust-gas turbocharger serving as low-pressure stage and the smaller exhaust-gas turbocharger as high-pressure stage. In this case the exhaust gases first pass through the smaller exhaust-gas turbocharger and deliver their residual energy to the larger exhaust-gas turbocharger in order to attain the basic engine speed. At high engine speeds or at full load the exhaust-gas turbochargers are connected in parallel, a large proportion of the exhaust gases and the charge-air flowing by a bypass between the inlet and outlet of the small turbocharger, which is intended to cover the upper power output range. The overall space available, which is limited due to this construction principle with internal turbochargers, limits the supercharging range. This inner V-shaped construction of the turbochargers can not be used in a conventional engine concept with exhaust line led outwardly.

German Published Patent Application No. 197 36 500 describes a multicylinder internal combustion engine having cylinder banks arranged in a V-shape and air booster housing provided in the V-shaped space, oil heat exchanger and exhaust gas recirculation cooler. In this case one exhaust-gas turbocharger is assigned to each cylinder bank.

An object of the present invention is to provide and arrange a reciprocating piston internal combustion engine with exhaust-gas turbochargers that may ensure simple and reliable retrofitting to or upgrading of the reciprocating piston internal combustion engine.

### SUMMARY

The above and other beneficial objects of the present invention may be achieved by providing a reciprocating piston internal combustion engine as described herein.

According to an example embodiment of the present invention the foregoing object may be achieved in that one first turbocharger and one second turbocharger each are assigned both to the first cylinder bank and to the second cylinder bank, the first turbocharger being larger than the second turbocharger. It is possible to assign one first turbocharger each to the first cylinder bank and the second cylinder bank and one second turbocharger to both of them jointly, the first turbocharger and the second turbocharger being of identical size. This may provide that optimum supercharging of the respective cylinder bank may be achieved according to the speed of the internal combustion engine, since the smaller second turbocharger may provide rapid supercharging at low engine speeds and the large second turbocharger may provide adequate supercharging in the rated engine speed range. Retrofitting to conventional engines is possible, since the size of the two first turbochargers and the size of the two second turbochargers or the one second turbocharger is manageable despite the overall space available. Although the exhaust gas and charge-air supply system becomes more complex, the use of at least three turbochargers may provide that the overall space available may be exploited to the full.

An additional possibility according to an example embodiment of the present invention is to connect the first charge-air compressor and the second charge-air compressor in series, the second charge-air compressor having a second bypass with a second control valve. At rated speed the larger charge-air volumetric flow of the second charge-air compressor may thereby be made to bypass the first charge-air compressor without sustaining any throttling effect.

It may be provided for the first exhaust-gas turbine and the second exhaust-gas turbine to be connected in series, the first exhaust-gas turbine having a first bypass with a first control valve.

It may be provided for the second exhaust-gas turbine to have a third bypass with a third control valve. With the third bypass closed, therefore, the entire exhaust gas flow is led to the first exhaust-gas turbine by the second exhaust-gas turbine. With the third bypass or third control valve opened or partially opened both exhaust-gas turbines are supplied in parallel with exhaust gas. The volumetric flow established through the two exhaust-gas turbines is determined by the throttling effect of the two exhaust-gas turbines and the third control valve.

According to an example embodiment of the present invention, it may be provided that in the lower engine speed range the second exhaust-gas turbine is connected in series upstream of the first exhaust-gas turbine and that the third bypass is closed. The smaller second exhaust-gas turbine reaches the charging speed faster than the larger first exhaust-gas turbine. The residual energy of the exhaust gas flow is converted in the first exhaust-gas turbine.

It may be provided that in the rated engine speed range the second exhaust-gas turbine and the first exhaust-gas turbine are at least partially connected in parallel by the third bypass. The smaller second exhaust-gas turbine extends in parallel with the first exhaust-gas turbine according to the position of the third control valve in the third bypass.

In the context of the development and arrangement according to the present invention it may be provided for the second turbocharger to be arranged as E-booster or electrical compressor. The use of an E-booster, that is an electrically driven or at least assisted compressor, may provide significant flexibility with regard to the possible instant of supercharging. Moreover, it is possible to use an electrically assisted turbocharger, so that the given exhaust gas energy is in any event also converted.

It is possible to provide an intercooler and a charge air intake system, which are arranged inside the two cylinder banks. This may provide that the upper area of the reciprocating piston internal combustion engine in proximity to the bonnet does not directly adjoin very solid and hot engine parts, so that technical safety aspects may be taken into account. The fuel supply may also still be arranged in the interior of the reciprocating piston internal combustion engine, there being no need to shift it outside in contravention of relevant safety aspects.

It may be provided for the second turbocharger to be arranged in front of the cylinder bank, viewed in the direction of travel, and the first turbocharger at the side in the exhaust area of the cylinder bank, and for the air filter to be arranged behind the cylinder bank, viewed in the direction of travel. The second turbocharger is in this case not provided in the area of the exhaust manifolds, so that it is possible to use an E-booster or an electrically assisted turbocharger at this point. The arrangement of the two first turbochargers in the area of the exhaust manifolds may ensure short exhaust gas paths when the reciprocating piston internal combustion engine is operating at rated output.

Further aspects and details of the present invention are explained in the following description and are represented in the drawings.

### BRIEF DESCRIPTION OF THE DRAWING

FIG. 1 is a schematic view of a reciprocating piston internal combustion engine having two cylinder banks each with two first turbochargers.

### DETAILED DESCRIPTION

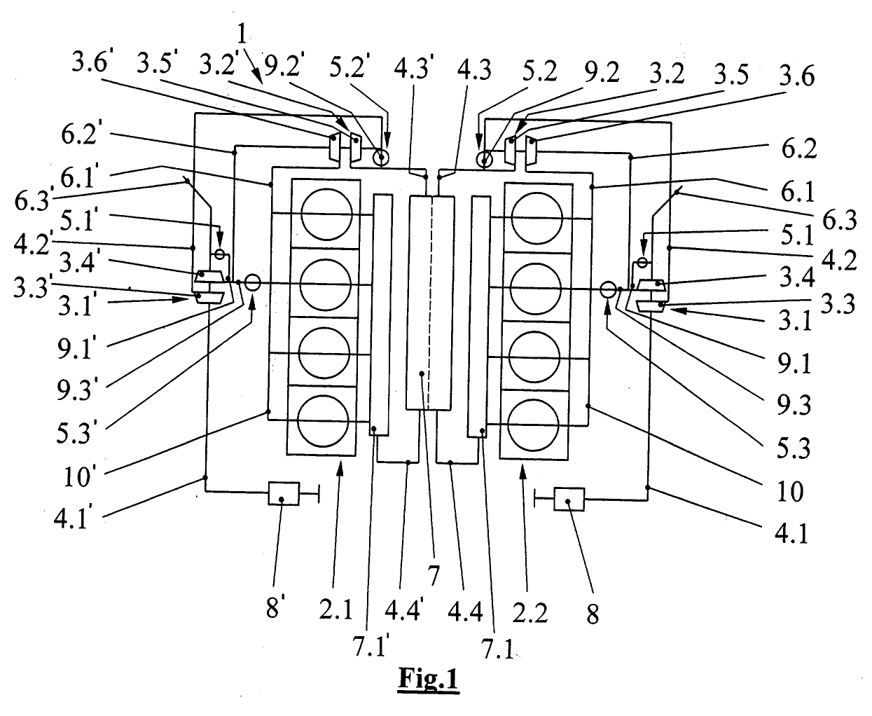

FIG. 1 illustrates a reciprocating piston internal combustion engine 1 having a first cylinder bank 2.1 and a second cylinder bank 2.2 each of four cylinders in line.

Assigned to each cylinder bank 2.1, 2.2 is a first turbocharger 3.1 with a first charge-air compressor 3.3 and a first exhaust-gas turbine 3.4, together with a second turbocharger 3.2 with a second charge-air compressor 3.5 and a second exhaust-gas turbine 3.6. The reciprocating piston internal combustion engine 1 is in this respect of symmetrical construction, so that only the right-hand side of FIG. 1 will be described below.

The first charge-air compressor 3.3 is flow-connected by a first charge-air line 4.1 to an intake system 8 including an air filter together with an air flow meter and by a second charge-air line 4.2 to the second charge-air compressor 3.5. The first charge-air compressor 3.3 and the second charge-air compressor 3.5 are connected by a third charge-air line 4.3 to an intercooler 7, which is coupled by a fourth charge-air line 4.4 to a charge-air distributor 7.1 for the second cylinder bank 2.2.

The second charge-air compressor 3.5 has a second bypass 9.2 having a second control valve 5.2.

The exhaust manifold 10 is flow-connected by a first exhaust line 6.1 to the second exhaust-gas turbine 3.6 and the latter by a second exhaust gas line 6.2 to the first exhaust-gas turbine 3.4. The tail silencer is connected to the first exhaust-gas turbine 3.4 by a third exhaust line 6.3.

The first exhaust-gas turbine 3.4 has a first bypass 9.1 with a first control valve 5.1.

The exhaust manifold 10 is connected by a third bypass 9.3 to the first exhaust gas turbine 3.4. A third control valve 5.3 is provided inside the third bypass 9.3. The second exhaust-gas turbine 3.6 may therefore be or alternatively be connected in parallel to the first exhaust-gas turbine 3.4 by the third bypass 9.3.

The two first turbochargers 3.1, 3.1′ are arranged at the side in the area of the exhaust manifolds 10, 10′ and the two second turbochargers 3.2, 3.2′ are arranged in front of the reciprocating piston internal combustion engine 1, viewed in the direction of travel.

It is possible to provide a common second turbocharger for the first cylinder bank 2.1 and the second cylinder bank 2.2 in place of the two second turbochargers 3.2, 3.2′.

What is claimed is:

1. A reciprocating piston internal combustion engine, comprising:
at least one first cylinder bank;
at least one second cylinder bank; and
at least two turbochargers assigned to each of the first and second cylinder banks, each turbocharger including a charge-air compressor and an exhaust-gas turbine, each of the at least two turbochargers including a first turbocharger and a second turbocharger, the first turbocharger larger than the second turbocharger.

2. The reciprocating piston internal combustion engine according to claim 1, wherein a first charge-air compressor and a second charge-air compressor are connected in series, the second charge-air compressor including a second bypass having a second control valve.

3. The reciprocating piston internal combustion engine according to claim 1, wherein a first exhaust-gas turbine and a second exhaust-gas turbine are connected in series, the first exhaust-gas turbine including a first bypass having a first control valve.

4. The reciprocating piston internal combustion engine according to claim 3, wherein the second exhaust-gas turbine includes a third bypass having a third control valve.

5. The reciprocating piston internal combustion engine according to claim 4, wherein, in a lower engine speed range, the second exhaust-gas turbine is connected in series upstream of the first exhaust-gas turbine and the third bypass is closed.

6. The reciprocating piston internal combustion engine according to claim 4, wherein the second exhaust-gas turbine and the first exhaust-gas turbine are configured to be connected at least partially in parallel by the third bypass in accordance with an attainment of a rated engine speed.

7. The reciprocating piston internal combustion engine according to claim 1, wherein the second turbocharger includes one of an E-booster and an electrical compressor.

8. The reciprocating piston internal combustion engine according to claim 1, further comprising an intercooler and a charge-air intake system arranged inside the two cylinder banks.

9. The reciprocating piston internal combustion engine according to claim 1, wherein the second turbocharger is arranged in front of the cylinder bank in a direction of travel and the first turbocharger is arranged at a side in an exhaust area of the cylinder bank, the reciprocating piston internal combustion engine further comprising an air filter arranged behind the cylinder bank in the direction of travel.

10. A reciprocating piston internal combustion engine, comprising:
at least one first cylinder bank;
at least one second cylinder bank; and
at least two turbochargers assigned to each of the first and second cylinder banks, each turbocharger including a charge-air compressor and an exhaust-gas turbine, the turbochargers including a first turbocharger assigned to each cylinder bank and a second turbocharger jointly assigned to the first cylinder bank and the second cylinder bank, the first turbocharger and the second turbocharger having and identical size.

11. The reciprocating piston internal combustion engine according to claim 10, wherein a first charge-air compressor and a second charge-air compressor are connected in series, the second charge-air compressor including a second bypass having a second control valve.

12. The reciprocating piston internal combustion engine according to claim 10, wherein a first exhaust-gas turbine and a second exhaust-gas turbine are connected in series, the first exhaust-gas turbine including a first bypass having a first control valve.

13. The reciprocating piston internal combustion engine according to claim 12, wherein the second exhaust-gas turbine includes a third bypass having a third control valve.

14. The reciprocating piston internal combustion engine according to claim 13, wherein, in a lower engine speed range, the second exhaust-gas turbine is connected in series upstream of the first exhaust-gas turbine and the third bypass is closed.

15. The reciprocating piston internal combustion engine according to claim 13, wherein the second exhaust-gas turbine and the first exhaust-gas turbine are configured to be connected at least partially in parallel by the third bypass in accordance with an attainment of a rated engine speed.

16. The reciprocating piston internal combustion engine according to claim 10, wherein the second turbocharger includes one of an E-booster and an electrical compressor.

17. The reciprocating piston internal combustion engine according to claim 10, further comprising an intercooler and a charge-air intake system arranged inside the two cylinder banks.

18. The reciprocating piston internal combustion engine according to claim 10, wherein the second turbocharger is arranged in front of the cylinder bank in a direction of travel and the first turbocharger is arranged at a side in an exhaust area of the cylinder bank, the reciprocating piston internal combustion engine further comprising an air filter arranged behind the cylinder bank in the direction of travel.
